(19) United States
(12) Patent Application Publication
(10) Pub. No.: US 2005/0242512 A1
(43) Pub. Date: Nov. 3, 2005

(54) Sealing device

(76) Inventor: Stephen John Flindall, Glengarnock (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/109,228

(22) Filed: Apr. 18, 2005

(30) Foreign Application Priority Data
Apr. 20, 2004 (GB) 0408753.2

(51) Int. Cl. F16L 37/00

(52) U.S. Cl. 277/314

(57) ABSTRACT

A sealing device for sealing two conduits comprising: a compressible sealing member; a first fastener adapted to retain the sealing member in a compressed state; and an actuator operable to compress the sealing member thus allowing unimpeded fastening or unfastening of the first fastener.

The present invention relates to devices for sealing two conduits using pressure activated seals. In particular, but not exclusively, the invention relates to devices for sealing a fixed conduit to a rotating conduit during drilling operations.

### BACKGROUND OF THE INVENTION

Sealing devices are required during drilling operations to connect the fixed pipe of the drilling fluid system to the rotating pipe of the drill string. This fixed-to-rotating interface is typically located at a drill string supporting device known as a swivel, Kelly spinner or top drive.

The seal between the fixed and rotating parts is typically formed using a replaceable cartridge that utilises pressure activated elastomeric seals. Conventional seals wear rapidly, typically within around 400 hours of use, and hence the cartridge must be replaced regularly. Replacement of the seal cartridge requires a substantial amount of down time. This down time is expensive and may be dangerous, as there is no means of injecting drilling fluid while the seal is being changed.

The conventional means for replacing the cartridge has a number of disadvantages. The swivel is located at a great height, in the top of the drilling derrick, and a person must be hoisted up to the swivel in order to replace the cartridge. Access to the wash pipe is via a small opening in the structure of the swivel. The person must reach into the opening and unfasten the top and bottom nuts, each of around 200 mm in diameter, using a heavy hammer to strike the lugs protruding from the nuts. The nuts must be hammered through the full length of their thread as the compressed seals provide a substantial biasing force which acts on the nuts and forces them against the threads of the pipe-work.

Fitting of a new cartridge has similar problems to removal of the existing cartridge. The new cartridge is placed between the two threads of the pipe-work. The nuts then have to be screwed on to the threads by hammering of the protruding lugs. As before, the nuts do not turn freely due to the biasing force from the compressed seals.

For the seal system to function correctly it is necessary for all of the elastomeric components of the seal to be fully compressed allowing the metal spacers and all the other metal components to be closed to a metal-to-metal condition.

Worn or dirty threads, inaccessibility, operational pressure and operator fatigue may all prevent the seal from being assembled correctly. It is common for the cartridge changing operation to take around two hours.

### SUMMARY OF THE INVENTION

According to a first aspect of the present invention there is provided a sealing device for sealing two conduits comprising:
a compressible sealing member;
a first fastener adapted to retain the sealing member in a compressed state; and
an actuator operable to compress the sealing member thus allowing unimpeded fastening or unfastening of the first fastener.

The term “unimpeded fastening or unfastening” should be interpreted to mean that there is substantially no force in the direction of the axes of the conduits which could impede fastening or unfastening of the first fastener.

Preferably the actuator interposes the sealing member and fastener.

Preferably the actuator comprises a piston which is slidable within a cylinder. Preferably the piston is hydraulically actuated. Alternatively, the piston is pneumatically actuated.

Preferably the piston comprises an annular sleeve. Preferably the first fastener is provided radially around the sleeve.

Preferably the sealing device includes a tube for locating the sealing device between the two conduits. Preferably the tube has a flange which abuts against the end of one of the conduits. Preferably the flange is adapted for engagement with the first or second fastener for fastening of the tube to one of the conduits. Preferably the flange is adapted for engagement with the actuator.

Preferably one of the conduits is a fixed conduit and the other of the conduits is a rotating conduit.

Preferably the first fastener comprises a nut having a screwed connection for fastening to one of the conduits. Preferably the sealing device includes a second fastener. Preferably the actuator allows unimpeded fastening or unfastening of the second fastener. Preferably the second fastener comprises a nut having a screwed connection for fastening to the other of the conduits.

Preferably the sealing member is provided in a housing. Preferably the housing is provided radially around the tube. Preferably the actuator is adapted to act upon the housing to compress the sealing member.

Preferably the first fastener is provided radially around the housing.

Preferably one or more pressure seals are provided between the piston and cylinder.

Preferably the cylinder is a two port cylinder for advancing and retracting the piston.

Preferably a first connecting means is provided for connecting the piston to the tube.

According to a second aspect of the present invention there is provided a method of sealing two conduits, comprising:
providing a compressible sealing member;
compressing the sealing member using an actuator;
fastening the sealing member to one of the conduits such that the sealing member is retained in a compressed state.

Preferably the method includes interposing the actuator between the sealing member and fastener such that the actuator does not interfere with fastening of the fastener.

Preferably one of the conduits is a fixed conduit and the other of the conduits is a rotating conduit.

Preferably the sealing member is provided in a housing and the actuator is adapted to act upon the housing to compress the sealing member.

Preferably the method includes retracting the actuator following fastening of the sealing member.

Preferably a method includes providing a tube between the two conduits. Preferably the method includes connecting the actuator to the tube.

### BRIEF DESCRIPTION OF THE DRAWINGS

An embodiment of the present invention will now be described, by way of example only, with reference to the accompanying drawings, in which:

FIG. 1 is a perspective view of a conventional swivel;

FIG. 2 is a sectional front view of the swivel of FIG. 1;

FIG. 3 is a detailed sectional front view of a portion of the swivel of FIG. 1;

FIG. 4 is a part sectional front view of two conduits to be sealed;

FIG. 5 is a part sectional front view of a sealing device according to the present invention with the actuator retracted;

FIG. 6 is a part sectional front view of the sealing device of FIG. 5 with the actuator extended;

FIG. 7 is another part sectional front view of the sealing device of FIG. 5 with the actuator extended; and

FIG. 8 is another part sectional front view of the sealing device of FIG. 5 with the actuator retracted.

### DETAILED DESCRIPTION OF THE DRAWINGS

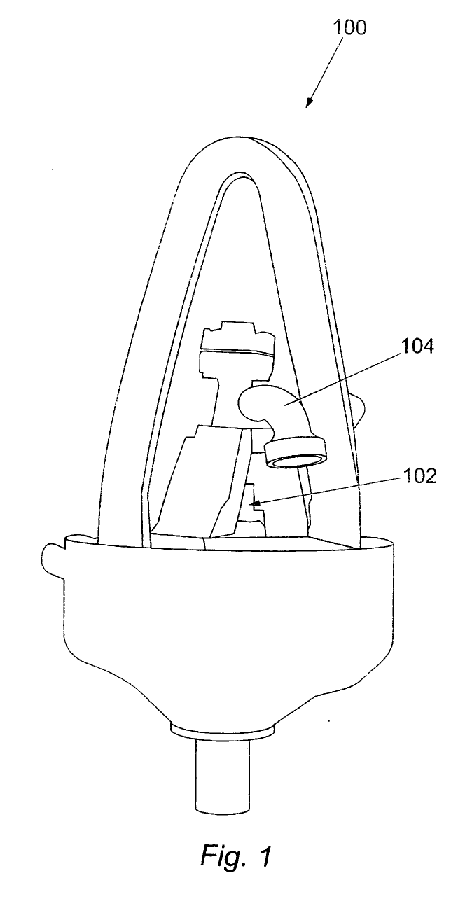

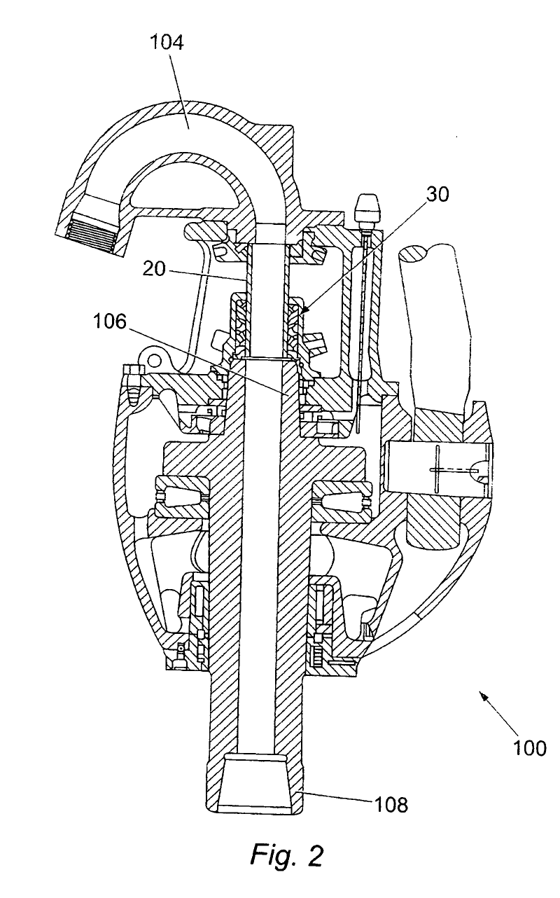

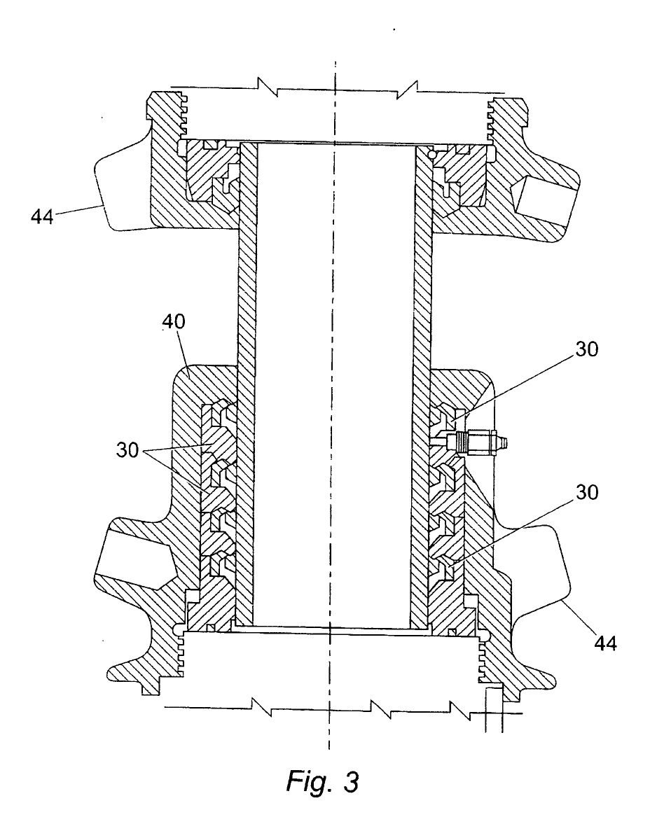

FIGS. 1 to 3 show a conventional swivel 100. Drilling fluid is fed into the swivel 100 through fixed pipe-work typically referred to as a gooseneck 104. The fluid enters the rotating section 106 of the swivel, via a tube, or wash pipe 20. The drill string is connected to a screwed component 108 at the bottom of the rotating portion.

Compressible, or pressure activated, seals 30 are arranged radially around the wash pipe 20. The seals 30 are provided in a housing which also defines a first fastener 40. The seals are retained in a compressed state by the first fastener 40 which is fastened to the rotating section 106. A second fastener 42 connects the wash pipe 20 to the gooseneck 104. Access to each of the fasteners is via an opening 102 provided at the swivel 100.

Each fastener includes a pair of lugs 44. These are provided for fastening and unfastening of the fasteners. The biasing force from the compressed seals acts upon each of the fasteners and thus fastening of unfastening of the fasteners is impeded.

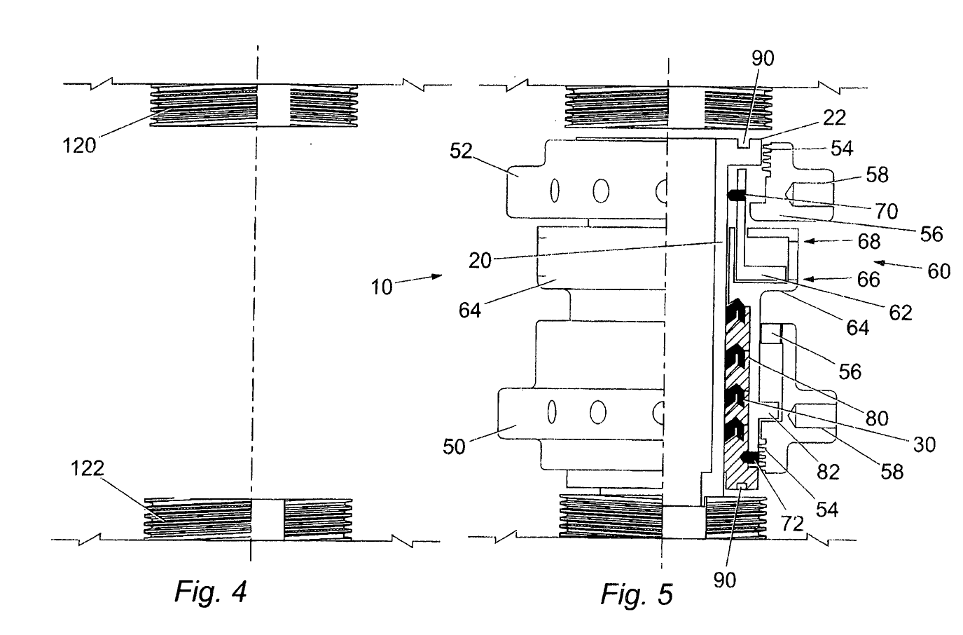

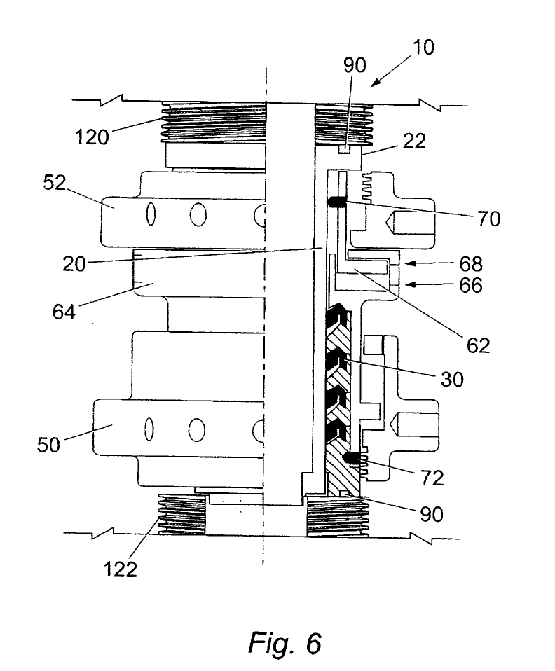

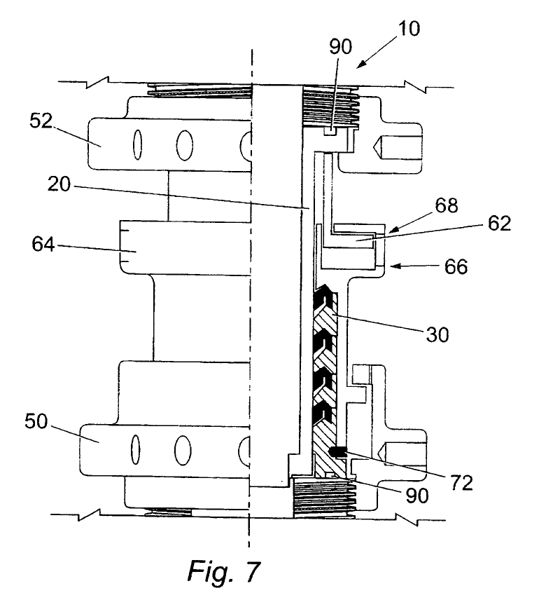

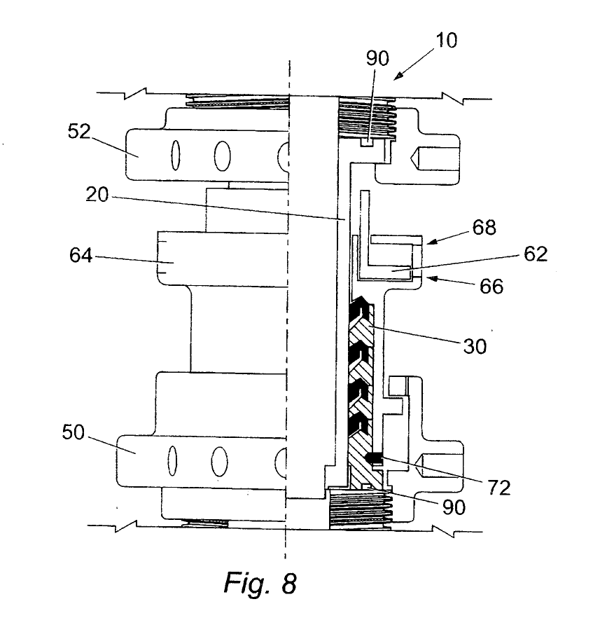

FIG. 4 shows first and second conduits 120, 122 associated with the goose neck 104 and rotating section 106 respectively. The conduits are spaced apart to allow insertion of the wash pipe 20.

FIG. 5 shows a sealing device 10 in accordance with the present invention. As before, the sealing device includes a compressible sealing member 30 arranged about a wash pipe 20. A first fastener in the form of a first nut 50 and a second fastener in the form of a second nut 52 are provided for connection to the conduits.

The sealing device 10 includes an actuator 60 which is operable to compress the sealing member 30 for unimpeded fastening or unfastening of each of the first and second fasteners. The actuator 60 comprises a piston 62 which is slidable within a cylinder 64.

The cylinder 64 includes a first port 66 and a second port 68 which allow connection to a hydraulic system (not shown) which includes a pressure source. The head of the piston 62 is provided between these two ports. Therefore, the piston 62 may be hydraulically extended or retracted depending on which port is connected to the pressure source.

The piston 62 comprises an annular sleeve which is arranged radially round the wash pipe 20. First connecting means in the form of a first set screw 70 and aperture are provided for connection of the piston 62 to the wash pipe 20. When the piston 62 is not connected to the wash pipe 20, the whole actuator and seal arrangement is slidable relative to the wash pipe 20.

The wash pipe 20 includes a flange 22 which abuts against the upper conduit 120. A pressure seal 90 is provided between the flange 22 and upper conduit 120. The piston 62, when extended, engages with an inner portion of the flange 22.

The second nut 52 is arranged radially around the wash pipe 20 and piston 62. The second nut 52 includes a threaded portion 54 and an annular protrusion 56 which engages with an outer portion of the flange 22 when the second nut 52 is screwed to the first conduit 120. Therefore, the actuator 60 is adapted to operate without interfering with the nut 52. The second nut 52 also includes a port 58 for receiving an end of a cheater bar (not shown) for assisting in fastening or unfastening of the nut.

The wash pipe 20 has a spigot at its bottom end to allow centralising on to the second conduit 122. The actuator 60 includes a recessed portion 80 which defines the housing for the seals 30. This differs from conventional arrangements where one of the fasteners defines the housing. The recessed portion 80 includes a protruding flange 82.

Second connecting means in the form of a second set screw 72 connects the recessed portion 80 to the seals 30. The second set screw 72 retains all of the sealing elements within the housing. The screw is fitted during bench assembly of the cartridge and allows movement of the sealing elements while preventing them from sliding out. It also causes the sealing elements to remain within the housing when the housing travels upwards.

The first nut 50 is arranged radially around the wash pipe 20 and recessed portion 80 of the actuator 60. The first nut 50 includes a threaded portion 54 and an annular protrusion 56 which engages with the flange 82 of the recessed portion 80 when the first nut 50 is screwed to the second conduit 122. The first nut 50 also includes a port 58 for receiving an end of a cheater bar.

In use, and starting from the position shown in FIG. 4, the sealing device 10, and wash pipe 20 in particular, is first slid into the space between the threaded faces of the first 120 and second 122 conduits. The spigot at the bottom of the wash pipe 20 centrally locates the device 10.

The first port 66 is connected to the pressure source such that pressure is applied to the underside of the piston 62 causing it to move upwards relative to the cylinder 60. The piston 62, after a certain amount of travel, makes contact with the flange 22 of the wash pipe 20, causing it to rise up until it makes contact with the fixed thread face of the first conduit 120. The piston 62 continues to stroke, causing the housing and seals 30 to move downwards. The seals 30 then make contact with the face of the second conduit 122 and are then compressed within the housing, thus energising the seals 30. An applied pressure from the pressure source is selected such that all of the metal components of the seal are caused to close up and the all of the elastomeric components are fully energised.

The first nut 50 may now be spun on to the thread of the second conduit until the protruding portion 56 of the nut makes contact with the flange 82. Similarly, the second nut 52 may now be spun on to the thread of the first conduit until the protruding portion 56 of the nut makes contact with the flange 22. It will be possible to turn each nut by hand (therefore unimpeded fastening) as the seals 30 are already energised and retained in a compressed state by the actuator 60. Each nut may then be tightened further by striking with a hammer or pulling on a cheater bar.

The set screw 70 is then removed thus disconnecting the piston 62 from the wash pipe 20. The pressure source is connected to the second port 68 so that pressure is applied to the topside of the piston 62 causing it to move downwards, thus clearing the fixed section from the rotating section. The device 10 may now be used.

The following steps may be taken in order to remove the device 10 for replacement.

The pressure source is connected to the first port 66 so that pressure is applied to the bottom side of the piston 62 causing it to move upwards, thus retaining the seals 30 in their energised state. The set screw 70 is screwed in to the piston 62 thus connecting it to the wash pipe 20.

Each of the first 50 and second 52 nuts are loosened by striking with a hammer or pulling on a cheater bar. Both nuts are then spun off of their respective threads.

The pressure source is then connected to the second port 68 so that pressure is applied to the top side of the piston 62 causing it to move downwards. As the piston 62 is connected to the wash pipe 20 via the set screw, the movement will be transmitted to the seals 30 within the housing. The housing will move upwards, drawing the seal elements with it. The shortened device 10 may now be lifted clear of its location.

The present invention uses an actuator 60 to fully compress and energise the seals. There is no interference between the actuator 60 and fasteners so that there is unimpeded fastening or unfastening of the fasteners. A large amount of time is therefore saved. Also, the seals 30 should be assembled correctly, thus increasing their life. Also, safety when replacing the seals will be improved.

Various modifications and improvements can be made without departing from the scope of the present invention.

1. A sealing device or sealing two conduits comprising:
a compressible sealing member;
a first fastener adapted to retain the sealing member in a compressed state; and
an actuator operable to compress the sealing member thus allowing unimpeded fastening of the first fastener.

2. A sealing device as claimed in claim 1, wherein the actuator is operable to compress the sealing member thus allowing unimpeded unfastening of the first fastener.

3. A sealing device as claimed in claim 1, wherein the actuator interposes the sealing member and the first fastener.

4. A sealing device as claimed in claim 1, wherein the actuator comprises a piston which is slidable within a cylinder.

5. A sealing device as claimed in claim 4, wherein the piston is hydraulically actuated.

6. A sealing device as claimed in claim 4, wherein the piston comprises an annular sleeve, the first fastener being provided radially around the sleeve.

7. A sealing device as claimed in claim 1, including a tube for locating the sealing device between the two conduits.

8. A sealing device as claimed in claim 7, wherein the tube has a flange which abuts against the end of one of the conduits.

9. A sealing device as claimed in claim 8, wherein the flange is adapted for engagement with one of the first and second fasteners for fastening of the tube to one of the conduits.

10. A sealing device as claimed in claim 8, wherein the flange is adapted for engagement with the actuator.

11. A sealing device as claimed in claim 1, wherein one of the conduits is a fixed conduit and the other of the conduits is a rotating conduit.

12. A sealing device as claimed in claim 1, wherein the first fastener comprises a nut having a screwed connection for fastening to one of the conduits.

13. A sealing device as claimed in claim 1, wherein the sealing device includes a second fastener, and wherein the actuator allows one of unimpeded fastening and unimpeded unfastening of the second fastener.

14. A sealing device as claimed in claim 13, wherein the second fastener comprises a nut having a screwed connection for fastening to the other of the conduits.

15. A sealing device as claimed in claim 1, wherein the sealing member is provided in a housing, the housing being provided radially around the tube.

16. A sealing device as claimed in claim 15, wherein the actuator is adapted to act upon the housing to compress the sealing member.

17. A sealing device as claimed in claim 4, wherein the actuator comprises a two port cylinder for advancing and retracting the piston.

18. A method of sealing two conduits, comprising:
providing a compressible sealing member;
compressing the sealing member using an actuator;
fastening the sealing member to one of the conduits such that the sealing member is retained in a compressed state.

19. A method as claimed in claim 18, including interposing the actuator between the sealing member and fastener such that the actuator does not interfere with fastening of the fastener.

20. A method as claimed in claim 18, including retracting the actuator following fastening of the sealing member.

21. A method as claimed in claim 18, including providing a tube between the two conduits and connecting the actuator to the tube.
